(19) United States
(12) Patent Application Publication
(10) Pub. No.: US 2015/0301769 A1
(43) Pub. Date: Oct. 22, 2015

(54) FUNCTION SETTING METHOD AND RECORDING MEDIUM

(71) Applicants: Yuu YAMASHITA, Kanagawa (JP); Naoyuki URATA, Kanagawa (JP); Kanna IINUMA, Kanagawa (JP); Teruyoshi YAMAMOTO, Tokyo (JP); Yukihiro HAYAKAWA, Kanagawa (JP); Kenichi FUJIOKA, Kanagawa (JP); Masahiro FUKUDA, Tokyo (JP); Akira TERUYA, Kanagawa (JP); Mitsutaka TAKEDA, Tokyo (JP); Yusuke KAWATSU, Tokyo (JP); Megumi OKUMURA, Tokyo (JP); Ken MITSUI, Kanagawa (JP)

(72) Inventors: Yuu YAMASHITA, Kanagawa (JP); Naoyuki URATA, Kanagawa (JP); Kanna IINUMA, Kanagawa (JP); Teruyoshi YAMAMOTO, Tokyo (JP); Yukihiro HAYAKAWA, Kanagawa (JP); Kenichi FUJIOKA, Kanagawa (JP); Masahiro FUKUDA, Tokyo (JP); Akira TERUYA, Kanagawa (JP); Mitsutaka TAKEDA, Tokyo (JP); Yusuke KAWATSU, Tokyo (JP); Megumi OKUMURA, Tokyo (JP); Ken MITSUI, Kanagawa (JP)

(73) Assignee: RICOH COMPANY, LTD., Tokyo (JP)

(21) Appl. No.: 14/688,494

(22) Filed: Apr. 16, 2015

(30) Foreign Application Priority Data
Apr. 17, 2014 (JP) 2014-085692

(51) Int. Cl. G06F 3/12

(52) U.S. Cl. CPC G06F 3/1231; G06F 3/1285

(57) ABSTRACT

Disclosed is a non-transitory recording medium storing a function setting program for utilizing an image forming apparatus. The function setting program, when processed by a processor, executes a process including receiving a page range to which page process functions settable by page unit are applied, by each of the page process functions, receiving a page range to which post process functions executable after forming an image are applied, by each of the post process functions, and displaying a list of the functions applied to each of the page ranges on a display part by associating the page range to which the post process functions are applied, among the page ranges to which the post process functions are applied, the page range to which image process functions are applied so as to identify types of the functions applied to a corresponding one of the page ranges.

### BACKGROUND OF THE INVENTION

1. Field of the Invention

The disclosures discussed herein relate to a function setting method and a recording medium storing a function setting program.

2. Description of the Related Art

Recently, electronic conversion of information has been increasingly encouraged, and image processing apparatuses such as printers or facsimile machines for outputting the electronically converted documents, and scanners for electronically converting documents are now becoming critical apparatuses. Such image processing apparatuses are provided with imaging functions, communication functions, and the like to form multi-functional peripherals (MFPs) used as printers, facsimile machines, scanners, and copiers.

When users use printers, among such MFPs, for outputting electronically converted documents, the users initially need to install printer drivers as software programs in information processing apparatuses such as personal computers (PCs). Then, after the users set in the printer drivers data subjected to outputting image formed results (hereinafter called “print target data”) and print conditions such as the numbers of print sets, the users operate the information processing apparatuses by following user interfaces (UI) provided by the installed printer drivers to generate print jobs and input the generated print jobs in respective printers. The users are able to cause the printers to produce image formed outputs in accordance with the desired print conditions.

Further, such printers are additionally provided with various functions so as to enable the users to execute printing based on various print conditions by using such functions. For example, the various functions include a duplex print function, an aggregate print function, a monochrome print function, a color print function, a sort function, a stack function, a fold function, a staple function, a punch function, a bind function, and the like.

In order for the printers to utilize such functions to perform printing, the users need to input the print jobs including print conditions associated with the above-described functions, in addition to the print conditions such as the print target data and the numbers of print sets. Hence, the users need to set the print conditions associated with the above-described functions in advance in addition to setting in the printer drivers the target data and the print conditions such as the numbers of print sets to generate the print jobs.

As such printer drivers, there are known in the art printer drivers to set the print conditions associated with the above-described functions by print job units, and printer drivers to set the print conditions associated with the above-described functions by page units. When one print job includes print target data of two or more pages, the former printer drivers merely allow the printer to print all the pages based on the same print conditions. However, the latter printer drivers allow, when one print job includes print target data having plural pages, the printer to print pages based on the different print conditions.

The printer driver for setting the print conditions in units of pages may be important not in outputting simple printed matter such as office or home printing but in product printing that is desired for outputting printed matter with high added value, such as print media or print conditions differing by page. This is because printed matter itself is a product in the product printing.

When utilizing such a printer driver to perform printing, the users need to set print conditions that are commonly applied throughout the pages as well as specifying the pages that the users desire to print based on other print conditions differing from the common print conditions. However, such a printer driver may require the users to set a different function for each page, thereby complicating settings of the print conditions. Hence, the users may feel burdened to set the print conditions.

There is a technology known in the art (e.g., Patent Document 1) to set separately two types of printer drivers among the above-described printer drivers. The printer drivers of the first type are configured to set print conditions associated with post process conditions such as a fold function, a staple function, a punch function, and the like (hereinafter may be generically called a “post process condition”) that are collectively set for a set of two or more pages, and the printer drivers of the second type are configured to set print conditions associated with page process functions such as a duplex print function, an aggregate print function, a monochrome print function, a color print function, and the like (hereinafter may be generically called a “page process condition”) that are set by each page.

The technology disclosed in Patent Document 1 enables the two types of drivers to separately set the post process conditions (applied to a set of two or more pages) and the page process conditions (applied by page), which may facilitate the users' setting operations to set the print conditions.

Hence, after the above-described settings are completed, the users are able to determine whether desired print conditions are set by monitoring a post process condition verification screen displaying post process condition setting content and a page range to which the post process setting content is applied, and a page process condition verification screen displaying a page process condition setting content and a page range to which the page process setting content is applied.

However, since a list associated with the post process conditions and a list associated with the page process conditions are displayed on different verification screens (i.e., the post process condition verification screen and the page process condition verification screen), the users may have difficulty in verifying a relationship between the page range in which the post process conditions are set and the page range in which the page process conditions are set. Hence, it may be difficult for the users to determine whether the desired print conditions are set.

Note that such difficulty is present not only in the printer drivers but is also present in function setting programs for setting functions for operating image forming apparatuses.

### RELATED ART DOCUMENT

### Patent Document

### Patent Document 1: Japanese Laid-open Patent Publication No. 2008-090631

### SUMMARY OF THE INVENTION

Accordingly, it is a general object in one embodiment of the present invention to provide a technology to improve users' usability of setting functions for utilizing an image forming apparatuses that substantially obviates one or more problems caused by the limitations and disadvantages of the related art.

According to an aspect of embodiments, there is disclosed a non-transitory recording medium storing a function setting program for setting functions including page process functions and post process functions for utilizing an image forming apparatus, the function setting program, which when processed by a processor, executing a process that includes receiving a page range to which, among the functions available in the image forming apparatus, the page process functions settable by page unit are applied, by each of the page process functions; receiving a page range to which, among the functions available in the image forming apparatus, the post process functions executable after forming an image are applied, by each of the post process functions; and displaying a list of the functions applied to each of the page ranges on a display part by associating the page range to which the post process functions are applied, among the page ranges to which the post process functions are applied, the page range to which image process functions are applied so as to identify types of the functions applied to a corresponding one of the page ranges.

Other objects, features and advantages of the present invention will become more apparent from the following detailed description when read in conjunction with the accompanying drawings.

### BRIEF DESCRIPTION OF THE DRAWINGS

FIG. 1 is a simplified diagram illustrating an overall configuration of an image forming system according to an embodiment;

FIG. 2 is a block diagram schematically illustrating a hardware configuration of a client terminal 1 according to the embodiment;

FIG. 3 is a block diagram schematically illustrating a functional configuration of the client terminal 1 according to the embodiment;

FIG. 4 is a block diagram schematically illustrating a functional configuration of a printer driver 400 according to the embodiment;

FIG. 5 is a diagram illustrating a display example of an overall setting screen according to the embodiment;

FIG. 6 is a diagram illustrating a display example of a post process setting screen according to the embodiment;

FIG. 7 is a diagram illustrating a display example of a page process setting screen according to the embodiment;

FIG. 8 is a diagram illustrating a display example of an exception setting verification screen according to the embodiment;

FIG. 9 is a diagram illustrating an example of a print result according to the embodiment;

FIG. 10 is an example of post process setting data stored in a setting data storage part according to the embodiment;

FIG. 11 is an example of page process setting data stored in the setting data storage part according to the embodiment;

FIG. 12 is an example of exception process setting data stored in a setting data storage part according to the embodiment;

FIG. 13 is a flowchart illustrating a process in which the printer driver according to the embodiment sets a page process condition in accordance with a user's operations;

FIG. 14 is a flowchart illustrating a process in which the printer driver according to the embodiment sets a post process condition in accordance with a user's operations; and

FIG. 15 is a flowchart illustrating a process in which the printer driver according to the embodiment displays an exception setting verification screen in accordance with a user's operations.

### DETAILED DESCRIPTION OF THE PREFERRED EMBODIMENTS

In the following, a description is given in detail of an embodiment of the present invention with reference to accompanying drawings. The following embodiment illustrates an example of an image forming system that includes image forming apparatuses configured to output images on transferred recording media, and printer drivers installed in client terminals in order to use the image forming apparatuses from the client terminals.

In such an image forming system, when users use printers for use in outputting digitized documents, the users are initially required to operate their client terminals to set data (hereinafter called “print target data”) from which the users desire to form and output images, and print conditions such as the number of print sets in accordance with user interfaces (UI) provided from the printer drivers installed in the client terminals.

Note that an image forming apparatus according to an embodiment may be provided with various functions such as a duplex print function, an aggregate print function, a monochrome print function, a color print function, a sort function, a stack function, a fold function, a staple function, a punch function, a bind function, and the like. Hence, in order for the users to utilize the above-described functions to cause the printers to perform printing, the users need to set the print target data and the print conditions such as the numbers of print sets in addition to setting the print conditions associated with the above-described functions in the printer driver to generate print jobs, and input the generated print jobs in the printers.

Further, the printer driver according to the embodiment is configured to set the print conditions associated with the above-described functions by page unit. Hence, when one print job includes print target data corresponding to two or more pages, these pages may be printed based on different print conditions.

Then, when the users utilize such a printer driver to carry out printing, the users may set print conditions applied throughout pages (hereinafter generically called “overall conditions”), and specify desired pages (hereinafter called “exception pages”) to be printed based on print conditions (hereinafter called “exception conditions”) differing from the overall conditions to individually apply the exception conditions to the specified exception pages.

In this case, the printer driver according to the embodiment is configured to separately set two types of the exception conditions. The first type exception conditions are print conditions associated with post process functions such as a fold function, a staple function, a punch function, and the like (hereinafter called “post process conditions”) that are applied to a set (bundle) of two or more pages, and the second type exception conditions are print conditions associated with page process functions such as a duplex print function, an aggregate print function, a monochrome print function, a color print function, and the like (hereinafter called a “page process condition”) that are applied to each of the pages.

The printer driver according to the embodiment is configured to display on a verification screen a list of setting contents associated with the post process conditions and setting contents associated with the page process conditions presented by each page range after these settings are completed. Hence, the users may be able to determine whether the users have set desired print settings.

One of the main features of the printer driver according to the embodiment may include a configuration capable of displaying on a verification screen the setting contents associated with the post process conditions and the setting contents associated with the page process conditions by each page range as a unit in which the post process conditions are set.

Hence, the printer driver according to the embodiment may enable the users to easily check the setting contents of the print conditions as well as enabling the users to easily verify a relationship between the page range in which the page process conditions are set and the page range in which the post process conditions are set.

Further, another object of the above-described printer driver according to the embodiment may include a configuration capable of dividing the page range in which the page process conditions are set on the basis of the page range in which the same (duplicated) post process conditions are set, and displaying the divided page ranges on a verification screen in a case where the duplicated page process conditions are set through two or more page ranges in which the post process conditions are set.

Hence, in the printer driver according to the embodiment, in a case where the same (duplicated) page process conditions are set through the two or more page ranges in which the post process conditions are set, the users may be able to easily verify the setting contents of the print conditions as well as easily verify a relationship between the page range in which the page process conditions are set and the page range in which the post process conditions are set.

With this configuration, the printer driver according to the embodiment may enable the users to easily verify whether the desired print settings are appropriately selected when the users set intended functions with respect to image forming apparatuses, thereby improving the convenience of the users.

Initially, operations of an image forming system according to an embodiment are described with reference to FIG. 1. FIG. 1 is a diagram illustrating operations of an image forming system according to an embodiment. As illustrated in FIG. 1, the image forming system according to the embodiment is configured to include a network 3 connected to a client terminal 1, a network 4 connected to an image forming apparatus 2 via a public line 5 such as the Internet or a telephone line.

Note that the number of client terminals 1 connected to the network 3 being one is only an example; however, a large number of client terminals 1 connected to the network 3 may form a large-scale image forming system. Further, the image forming system according to the embodiment may be formed of two or more networks connected to different client terminals 1 that are connected to the image forming apparatus 2 via a public line 5 such as the Internet or a telephone line, or may be formed of the client terminals 1 and the image forming apparatus 2 that are connected to the identical network.

The client terminal 1 is an information processing terminal operated by a user, and the client terminal 1 is implemented by an information processing apparatus such as a personal computer (PC). Note that the client terminal 1 may be a mobile information terminal such as a personal digital assistant (PDA), a smartphone, or a tablet terminal. Further, the client terminal 1 according to the embodiment has installed a printer driver serving as special software for utilizing the image forming apparatus 2.

Accordingly, the client terminal 1 according to the embodiment is configured to convert data subjected to printing (hereinafter referred to as “print target data”) into image data such as print description language (PDF) data or job definition format (JDF) data to generate print jobs for causing the image forming apparatus 2 to output image formed results by a user's operations. Note that when the image forming apparatus 2 is capable of processing the print target data themselves, the print target data may be handled as the image data.

The image forming apparatus 2 is provided with an imaging function, a communication function, and the like to form a multi-functional peripheral (MPF) used as a printer, a facsimile machine, a scanner, and a copier. Further, the image forming apparatus 2 includes a color printer or monochrome printer function configured to generate cyan magenta yellow key-plate (CMYK) or monochrome drawing data based on image data included in a print job transmitted from the client terminal 1, and output image formed results with respect to supplied sheets based on the generated drawing data.

In addition, the image forming apparatus 2 according to the embodiment further includes a duplex print function, an aggregate print function, a sort function, a stack function, a fold function, a staple function, a punch function, a bind function, and the like, and implements these functions based on the print conditions associated with the respective functions included in the print job transmitted from the client terminal 1.

Note that the networks 3 and 4 in FIG. 1 may, for example, be restricted networks such as office local area networks (office LANs). Hence, the client terminal 1 and the image forming apparatus 2 may be configured to be connected to the public line 5 via the respective LANs, but may also be configured to be connected directly to the public line 5.

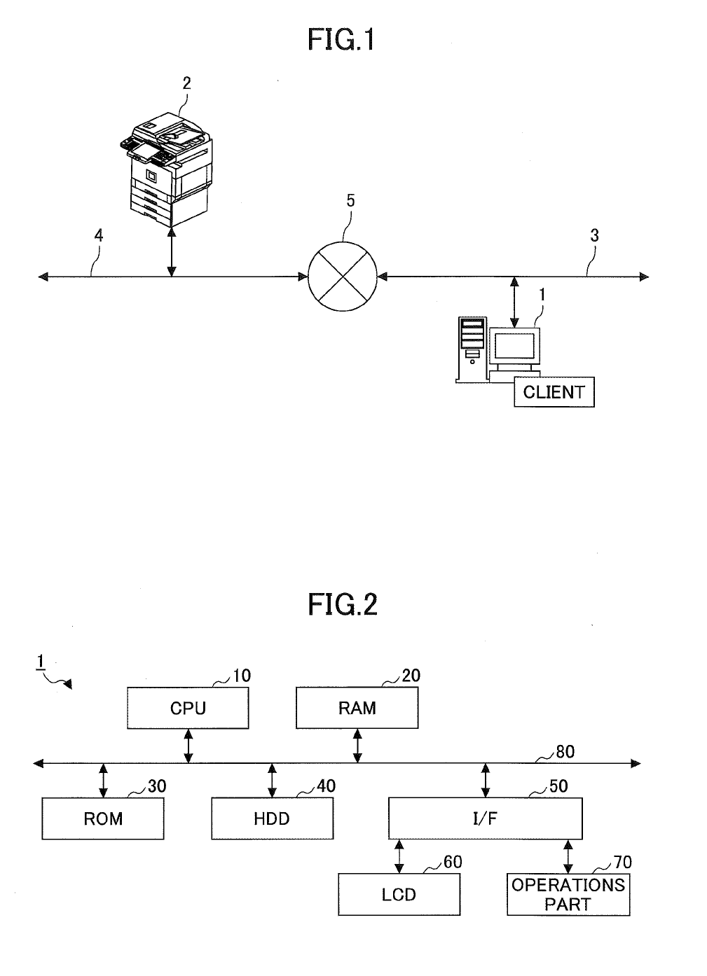

Next, a description is given of hardware configurations of the client terminal 1 and the image forming apparatus 2 according to the embodiment with reference to FIG. 2. FIG. 2 is a block diagram schematically illustrating a hardware configuration of the client terminal 1 according to the embodiment. Note that the image forming apparatus 2 is provided with an engine for implementing a scanner function, a printer function, a staple function, a fold function, a bind function, and the like. The following illustration is given of a hardware configuration of the client terminal 1 as an example; however, the hardware configuration may also be applied to the image forming apparatus 2.

As illustrated in FIG. 2, the client terminal 1 according to the embodiment includes a configuration similar to that of a generic server or a personal computer (PC). That is, the client terminal 1 according to the embodiment includes a central processing unit (CPU) 10, a random access memory (RAM) 20, a read only memory (ROM) 30, a hard disk drive (HDD) 40, and an I/F 50 that are connected to one another via a bus 80. Further, a liquid crystal display 60 and an operations part 70 are connected to the I/F 50.

The CPU 10 is an arithmetic part configured to control an overall operation of the client terminal 1. The RAM 20 is a readable-writable volatile recording medium configured to serve as a work area used by the CPU 10 that processes information. The ROM 30 is a read only non-volatile recording medium configured to store programs such as firmware or the like. The HDD 40 is an information readable-writable non-volatile recording medium configured to store an operating system (OS), various control programs, application programs, and the like.

The I/F 50 is configured to connect the bus 80 and various hardware and/or networks, and control the connection of the bus 80 and the various hardware and/or networks. The LCD 60 is a visual user interface for a user to verify or monitor a status of the client terminal 1. The operations part 70 is a user interface such as a keyboard, a mouse, and the like for a user to input information into the client terminal 1.

In such a hardware configuration, a software controller may be configured to load the programs stored in a recording medium such as the ROM 30 and the HDD 40 or a not-illustrated optical disk in the RAM 20, and cause the CPU 10 to perform operations in accordance with the programs loaded in the RAM 20. A combination of the software controller configured as above and the hardware may form a functional block to implement the client terminal 1 according to the embodiment.

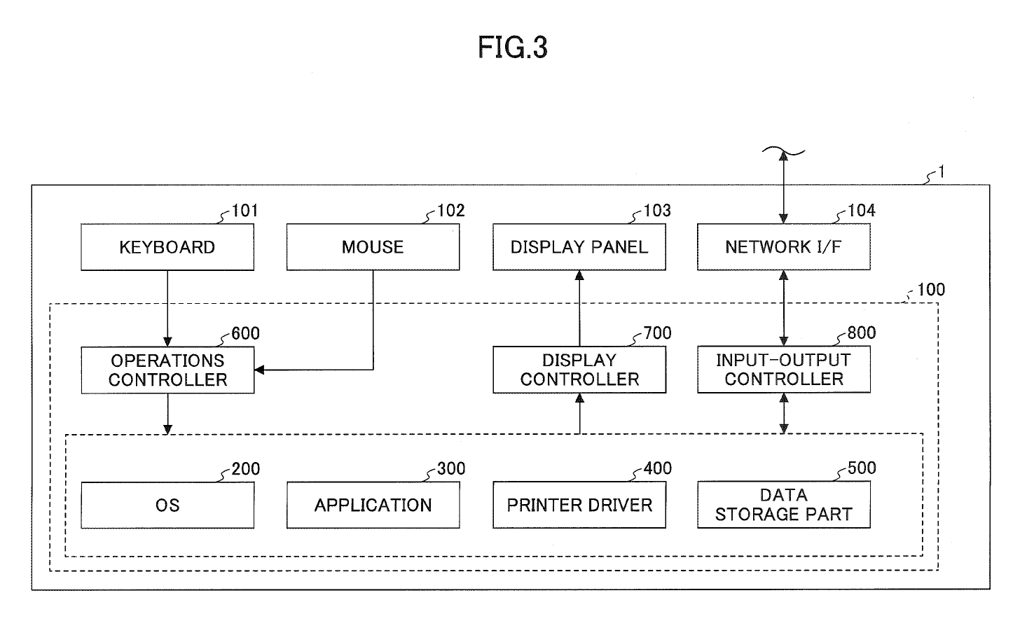

Next, a description is given of a functional configuration of the client terminal 1 according to the embodiment with reference to FIG. 3. FIG. 3 is a block diagram schematically illustrating the functional configuration of the client terminal 1 according to the embodiment.

As illustrated in FIG. 3, the client terminal 1 according to the embodiment includes a controller 100, a keyboard 101, a mouse 102, a display panel 103, and a network I/F 104. Further, the controller 100 includes an operating system (OS) 200, an application 300, a printer driver 400, a data storage part 500, an operations controller 600, a display controller 700, and an input-output controller 800.

The keyboard 101 and the mouse 102 are input interfaces for a user to operate the client terminal 1 or for a user to input information into the client terminal 1. The keyboard 101 and the mouse 102 may be implemented by the operations part 70 illustrated in FIG. 2. The display panel 103 is an output interface configured to visually display a status of the client terminal 1. The display panel 103 is implemented by the LCD 60 illustrated in FIG. 2. That is, the display panel 103 serves as a display part in this embodiment.

The network I/F 104 is an interface for the client terminal 1 to communicate with another apparatus such as the image forming apparatus 2 or the like via the network. Examples of the network I/F 104 include Ethernet (registered trademark) or a universal serial bus (USB) interface, Bluetooth (registered trademark), wireless fidelity (Wi-Fi)(registered trademark), and Felica (registered trademark) interfaces. As described above, the client terminal 1 is configured to transmit image data to be printed by the image forming apparatus 2 or various types of control commands such as a print request to the image forming apparatus 2 connected via the network I/F 104. The network I/F 104 is implemented by the I/F 50 illustrated in FIG. 2.

The controller 100 is formed of a combination of software and hardware. Specifically, the controller 100 is configured with a combination of a software controller and hardware such as an integrated circuit. The software controller is implemented by the CPU and performs operations in accordance with a control program such as firmware that is stored in the non-volatile recording medium such as the ROM 30 or the HDD 40, and loaded in the RAM 20. The controller 100 serves as a controller configured to control an overall function of the client terminal 1.

An OS 200 is an operating system such as Microsoft Windows (registered trademark), Linux (registered trademark), and the like. The application 300 is software directly including a text edit program, a word processor, a spreadsheet, and the like with which the user desires to perform tasks on the client terminal 1.

The printer driver 400 is a device driver for utilizing the image forming apparatus 2. The printer driver 400 is configured to display a setting screen serving as a UI for a user to set print target data and print conditions on the display panel 103 of the client terminal 1, and generate print jobs for causing the image forming apparatus 2 to execute printing in accordance with the set print target data and the set print conditions. The data storage part 500 is configured to store data such as print target data. The data storage part 500 is implemented by a volatile recording medium such as the RAM 20 illustrated in FIG. 2, or a non-volatile recording medium such as the HDD 40.

The operations controller 600 is configured to input information supplied via the keyboard 101 and the mouse 102 into each of operations parts such as the OS 200, the application 300, the printer driver 400, and the like that operate on the client terminal 1. The display controller 700 is configured to display information on the display panel 103. The input-output controller 800 is configured to input information supplied via the network I/F 104 into each of operations parts such as the OS 200, the application 300, the printer driver 400, and the like that operate on the client terminal 1.

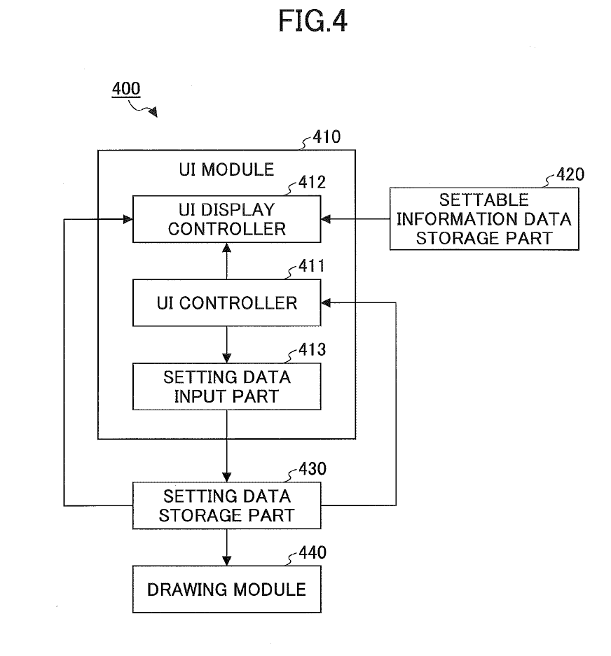

Next, a description is given of a functional configuration of the printer driver 400 according to the embodiment with reference to FIG. 4. FIG. 4 is a block diagram schematically illustrating a functional configuration of the printer driver 400 according to the embodiment. As illustrated in FIG. 4, the printer driver 400 according to the embodiment includes an UI module 410, a settable information storage part 420, a setting data storage part 430, and a drawing module 440. Further, the UI module 410 includes a UI controller 411, a UI display controller 412, and a setting data input part 413.

The UI module 410 is configured to display a setting screen serving as the UI for a user to set the print target data and the print conditions (hereinafter generically called “setting data”) on the display panel 103 of the client terminal 1, and receive the setting data input via the setting screen by the user's operations. Further, the UI module 410 displays a verification screen serving as a UI for a user to verify the print conditions set via the setting screen on the display panel 103 of the client terminal 1. The UI controller 411 is configured to control respective components included in the UI module 410.

The UI display controller 412 is configured to generate setting screen display information for displaying a setting screen serving as a UI for a user to set the print conditions, based on the settable information stored in the later-described settable information storage part 420.

Note that the configuration of this embodiment includes a setting screen for setting overall conditions (hereinafter called an “overall setting screen”), a setting screen for setting page process conditions (hereinafter called a “page process setting screen”), and a setting screen for setting post process conditions (hereinafter called a “post process setting screen”). Hence, in this configuration, the user may be able to set the overall conditions as well as setting the page process conditions and the post process conditions separately.

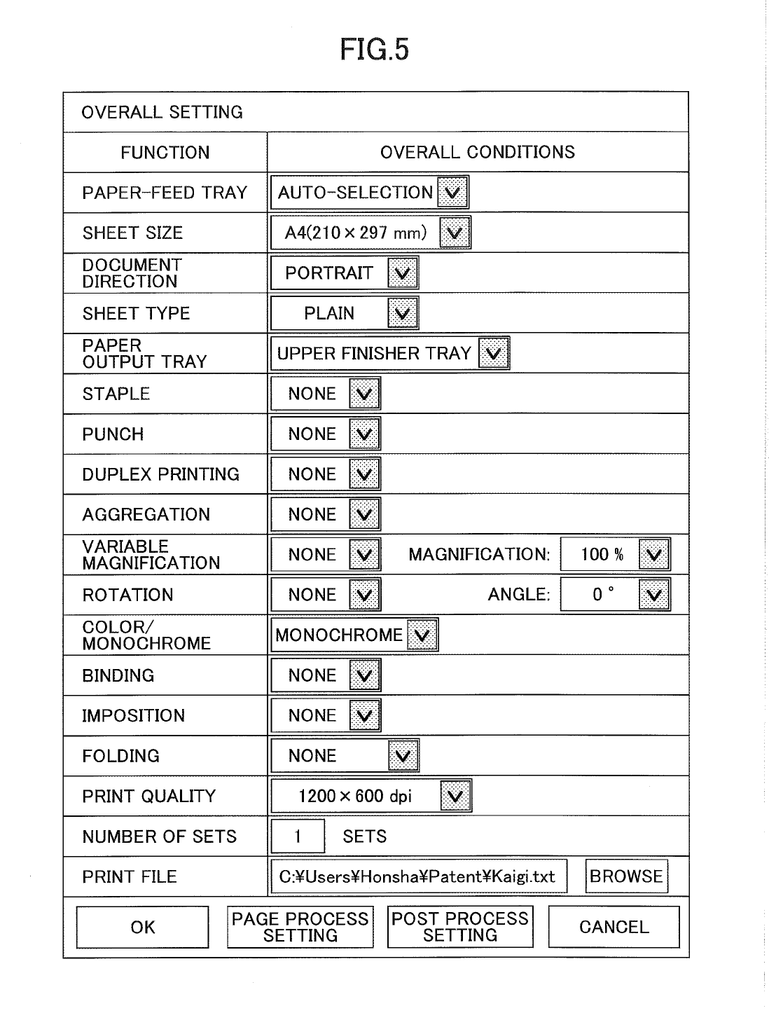

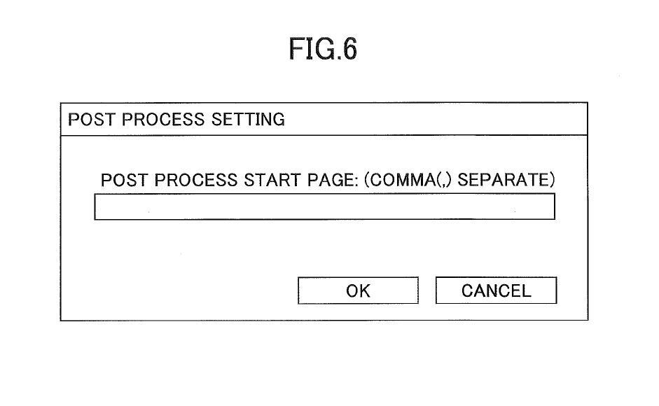

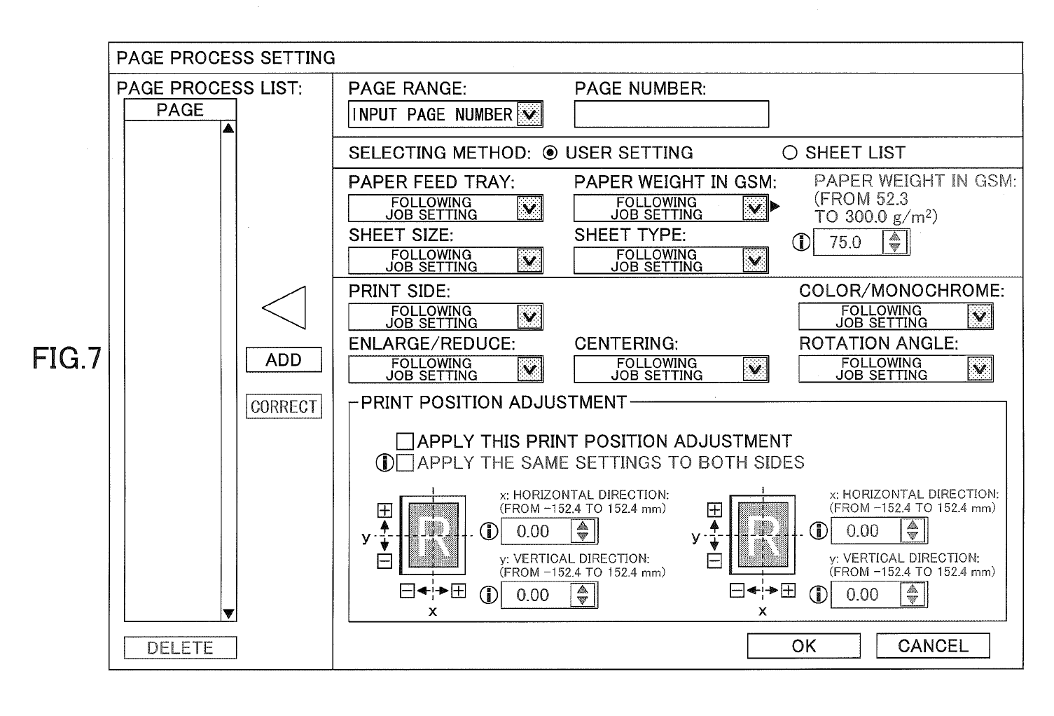

Note that the setting screens according to the embodiment are described with reference to FIGS. 5, 6, and 7. FIG. 5 is a diagram illustrating a display example of an overall setting screen according to the embodiment. FIG. 6 is a diagram illustrating a display example of a post process setting screen according to the embodiment. FIG. 7 is a diagram illustrating a display example of a page process setting screen according to the embodiment.

As illustrated in FIG. 5, in the overall setting screen according to the embodiment, a “function” column displays a list of functions included in the image forming apparatus 2, a “print condition” column displays selectable print conditions for the respective functions displayed in the “function” column when the image forming apparatus 2 outputs image formed results.

The “print file” of the function column is an item that indicates a storage location of the print file of the print target data to be input by the user's operations. Hence, in the image forming system according to the embodiment, when the image forming output is sent from the client terminal 1 to the image forming apparatus 2, the print file stored in the storage location input in the “print file” column may be printed. Thus, in the image forming system according to the embodiment, the user may set the print target data and the overall conditions on the overall setting screen as illustrated in FIG. 5.

Further, as illustrated in FIG. 5, the overall setting screen includes a post process setting button and a page process setting button. The user may be able to display one of a post process screen and a page process setting screen by depressing a corresponding one of these buttons.

Further, as illustrated in FIG. 6, in the post process setting screen according to the embodiment, the user may be able to specify a start page of the page range to which the post process conditions are applied. Note that in the post process setting screen, the user is only allowed to specify the start page of the page range to which the post process conditions are applied and not allowed to set detailed contents of the post process conditions. However, the post process setting screen may be configured such that the user may be able to set detailed contents of the post process conditions in a manner similar to that of the page process conditions.

Moreover, as illustrated in FIG. 7, in the page process setting screen according to the embodiment, page process functions are displayed such that the user is allowed to select the page process functions settable by page unit, and the user is also allowed to specify the page range to which the page process functions are applied. Note that a combo box for setting the page range is configured to display a list of the page ranges set via the post process screen, and hence, the user may be able to easily specify the page range to which the post process conditions are applied.

Further, the UI display controller 412 is configured to generate verification screen display information for displaying a verification screen that is a user interface (UI) for the user to verify contents set as the print conditions via the setting screen based on setting data stored in the later-described setting data input part 413, and to display the verification screen on the display panel 103 via the display controller 700 in accordance with the generated verification screen display information.

Note that the following embodiments include a verification screen for verifying the setting contents of the overall conditions (hereinafter called an “overall setting verification screen”), and a verification screen (hereinafter called an “exception setting verification screen”) for verifying setting contents of the exception conditions and the page range in which the exception conditions are set. Hence, the user may be able to determine the setting contents of the overall conditions as well as checking the setting contents of the exception conditions and the page range in which the exception conditions are set.

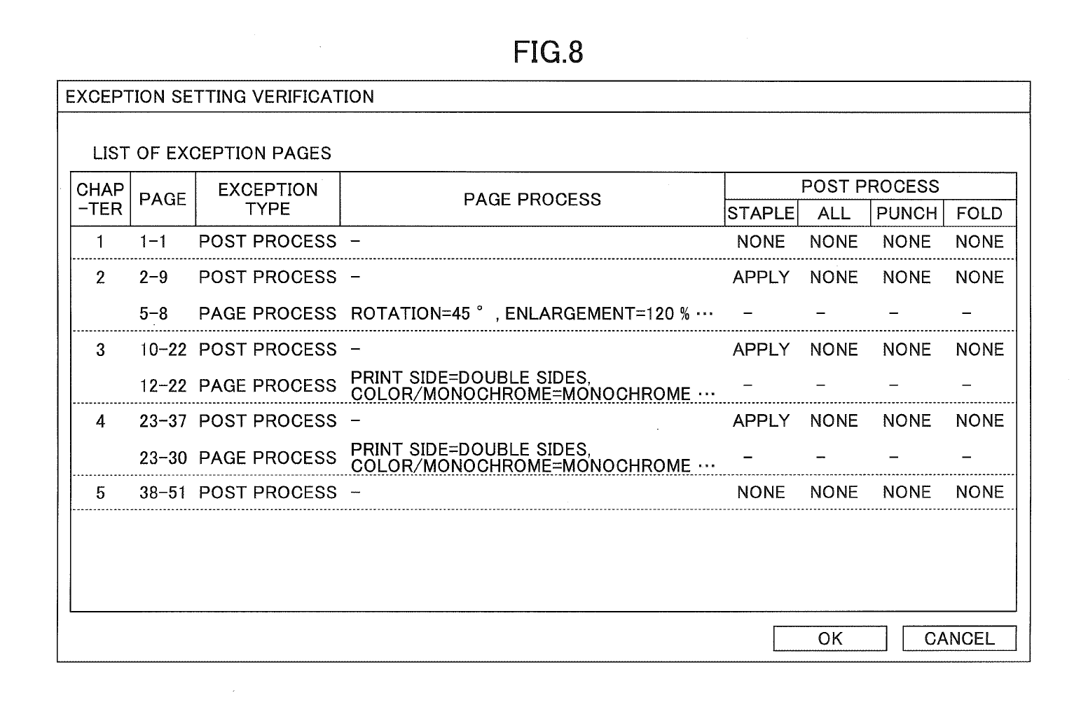

Note that in the following, the exception setting screen according to the embodiment is described with reference to FIG. 8. FIG. 8 is a diagram illustrating a display example of an overall setting screen according to the embodiment. Note that in this embodiment, each of the page ranges specified via the post process setting screen illustrated in FIG. 6 is called a “chapter”, and an index such as a natural number attached to each of the chapters identifies a corresponding page range, serving as identification information for identifying respective chapters.

As illustrated in FIG. 8, the exception setting verification screen according to the embodiment is configured to display the setting contents associated with the post process conditions and the setting contents associated with the page process conditions, by each chapter in which the post process conditions are set. Further, as illustrated in FIG. 8, the exception setting verification screen according to the embodiment may display types of exceptions indicating the settings of the post process conditions or the settings of the page process conditions, by each page range in which the post process conditions are set, and each page range in which the page process conditions are set, respectively, in addition to displaying the types of exceptions by each chapter. As a result, the user may be able to easily grasp the contents of the page process conditions that are set in the respective chapters. The printer driver 400 according to the embodiment may include the above-described main configuration.

Hence, the printer driver 400 according to the embodiment may enable the users to easily check the setting contents of the print conditions as well as enabling the users to easily verify a relationship between the page range in which the page process conditions are set and the page range in which the post process conditions are set.

Further, as illustrated in FIG. 8, the exception setting screen according to the embodiment may display, when the same (duplicated) page process conditions are set through two or more chapters in which post process conditions are set, the page range in which the page process conditions are set is divided on the basis of the chapter having the duplicated page process conditions, and the divided page ranges are displayed on the verification screen. Further, as illustrated in FIG. 8, the exception setting verification screen according to the embodiment may display types of exceptions indicating the settings of the post process conditions or the settings of the page process conditions, by each page range in which the post process conditions are set, and each page range in which the page process conditions are set, respectively, in addition to displaying the types of exceptions by each chapter. As a result, the user may be able to easily grasp the contents of the page process conditions that are set through appropriate chapters. The printer driver 400 according to the embodiment may include the above-described one of the main configuration.

Hence, in the printer driver 400 according to the embodiment, in a case where the same (duplicated) page process conditions are set through two or more chapters in which the post process conditions are set, the users may be able to easily verify the setting contents of the print conditions as well as easily verify a relationship between the page range in which the page process conditions are set and the page range in which the post process conditions are set.

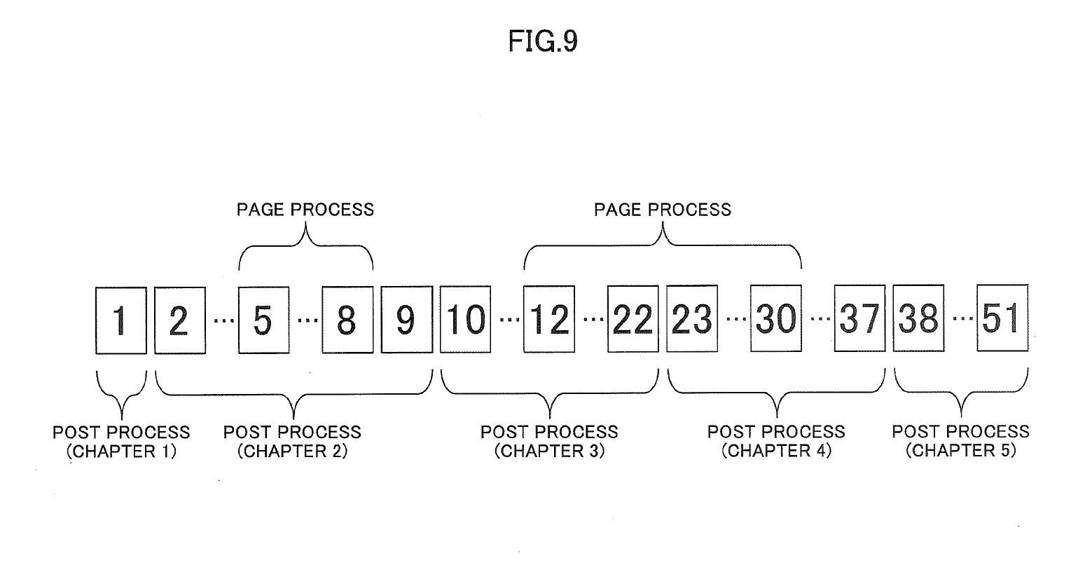

That is, the user may be able to easily conceive an image of the print result illustrated in FIG. 9 by monitoring (checking) the print conditions on the exception setting screen according to the embodiment. FIG. 9 is a diagram illustrating a print result according to the embodiment.

The setting data input part 413 is configured to receive an input of setting data by the user's operation on the setting screen to cause the input in the setting data storage part 430. The UI display controller 412 is configured to generate verification screen display information based on the setting data stored in the setting data input part 413.

For example, the settable information data storage part 420 may store settable information associated with formats, functions, and ranges settable by the printer driver 400 such as a specified range of the number of print sheets, a specified range of variable magnification, presence or absence of the staple setting, and presence or absence of aggregation setting. The settable information storage part 420 may be implemented by the HDD 40 illustrated in FIG. 2. The UI display controller 412 may generate setting screen display information based on the settable information stored in the settable information storage part 420.

The setting data storage part 430 is configured to store setting data input by the user's operations on the setting screen.

Note that the setting data storage part 430 may be configured to separately store setting data associated with the overall conditions (hereinafter “overall setting data”), setting data associated with the page process conditions (hereinafter “page process setting data”), setting data associated with the post process conditions (hereinafter “post process setting data”), and setting data associated with the merged page process conditions and the post process conditions (hereinafter “exception process setting data”).

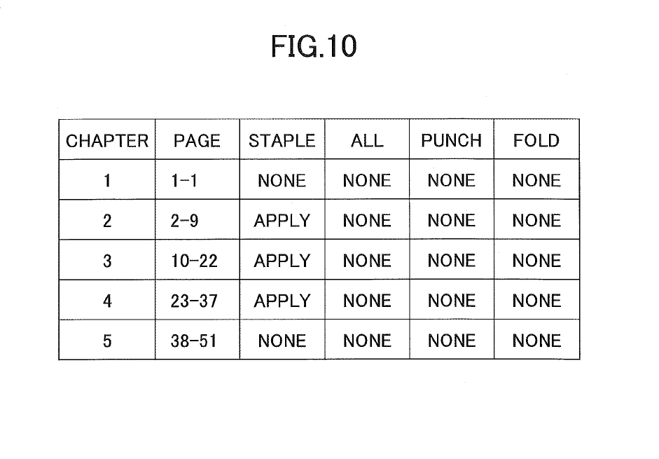

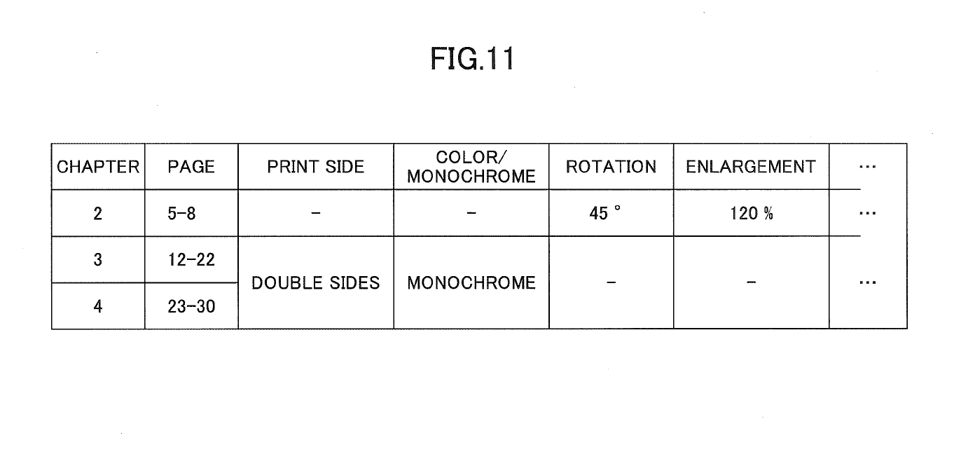

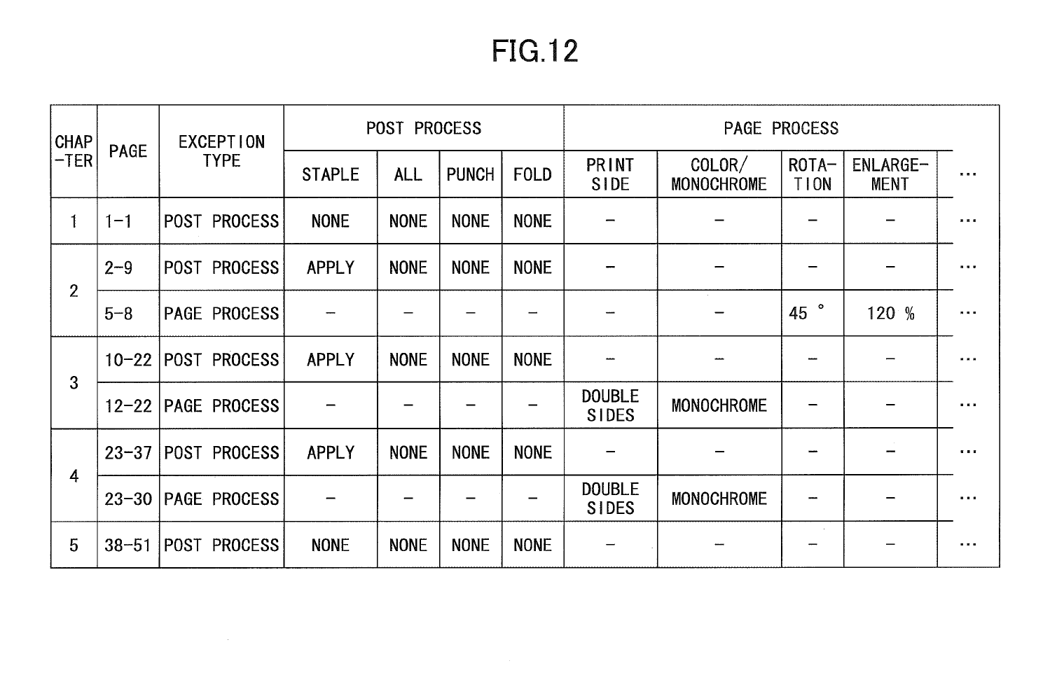

Note that the setting data according to the embodiment are described with reference to FIGS. 10, 11, and 12. FIG. 10 is a diagram illustrating an example of post process setting data stored in the setting data storage part 430 according to the embodiment. FIG. 11 is a diagram illustrating an example of page process setting data stored in the setting data storage part 430 according to the embodiment. FIG. 12 is a diagram illustrating an example of exception process setting data according to the embodiment.

As illustrated in FIG. 10, the setting data storage part 430 according to the embodiment is configured to associate the page ranges in which the post process conditions are set with the corresponding chapters so as to store, as post process setting data, setting contents set in the respective page ranges by each chapter.

Further, as illustrated in FIG. 11, the setting data storage part 430 is configured to configured to associate the page ranges in which the page process conditions are set with the corresponding chapters in which the post process conditions are set simultaneously with the page process conditions so as to store, as page process setting data, setting contents set in the respective page ranges by each chapter.

Accordingly, as illustrated in FIG. 11, the setting data storage part 430 according to the embodiment is configured to divide, when the same (duplicated) page process conditions are set through two or more chapters in which the post process conditions are set, the page process setting data on the basis of the chapter having the duplicated page range in which the page process conditions are set so as to store the divided page process setting data.

Further, as illustrated in FIG. 12, the setting data storage part 430 according to the embodiment is configured to store, as exception process setting data, the setting contents associated with the post process conditions and the setting contents of the page process conditions by each chapter in which the post process conditions are set. In this case, as illustrated in FIG. 12, in addition to the respective chapters, types of exceptions indicating the settings of the post process conditions or the settings of the page process conditions may be stored by each page range in which the post process conditions and the page process conditions are set.

Further, in a case where the same (duplicated) page process conditions are set through two or more chapters in which the post process conditions are set, the setting data storage part 430 according to the embodiment divides the page range in which the page process conditions are set on the basis of the duplicated chapter, and stores the divided page ranges as exception process setting data as illustrated in FIG. 12. In this case, as illustrated in FIG. 12, in addition to the respective chapters, types of exceptions indicating the settings of the post process conditions or the settings of the page process conditions may be stored by each page range in which the post process conditions and the page process conditions are set.

The drawing module 440 is configured to generate a print job based on the setting data stored in the setting data storage part 430.

One of the main functions of the printer driver 400 according to the embodiment may be a capability of displaying on a verification screen the setting contents associated with the post process conditions and the setting contents associated with the page process conditions by each chapter as a unit in which the post process conditions are set.

Hence, the printer driver 400 according to the embodiment may enable the users to easily check the setting contents of the print conditions as well as enabling the users to easily verify a relationship between the page range in which the page process conditions are set and the page range in which the post process conditions are set.

Further, another main function of the printer driver 400 may be, when the same page process conditions are set through two or more chapters in which the post process conditions are set, a capability of dividing the chapter between a start page having the duplicated page range in which the page process conditions are set and a page previous to the start page of the chapter so as to display the divided page ranges of the chapter on the verification screen.

Hence, in the printer driver 400 according to the embodiment, in a case where the page process conditions are set through two or more chapters in which the post process conditions are set, the users may be able to easily verify the setting contents of the print conditions as well as easily verify a relationship between the page range in which the page process conditions are set and the page range in which the post process conditions are set.

With this configuration, the printer driver 400 according to the embodiment may enable the users to easily verify whether the desired print settings are appropriately selected when the users set intended functions with respect to image forming apparatuses, thereby improving the convenience of the users.

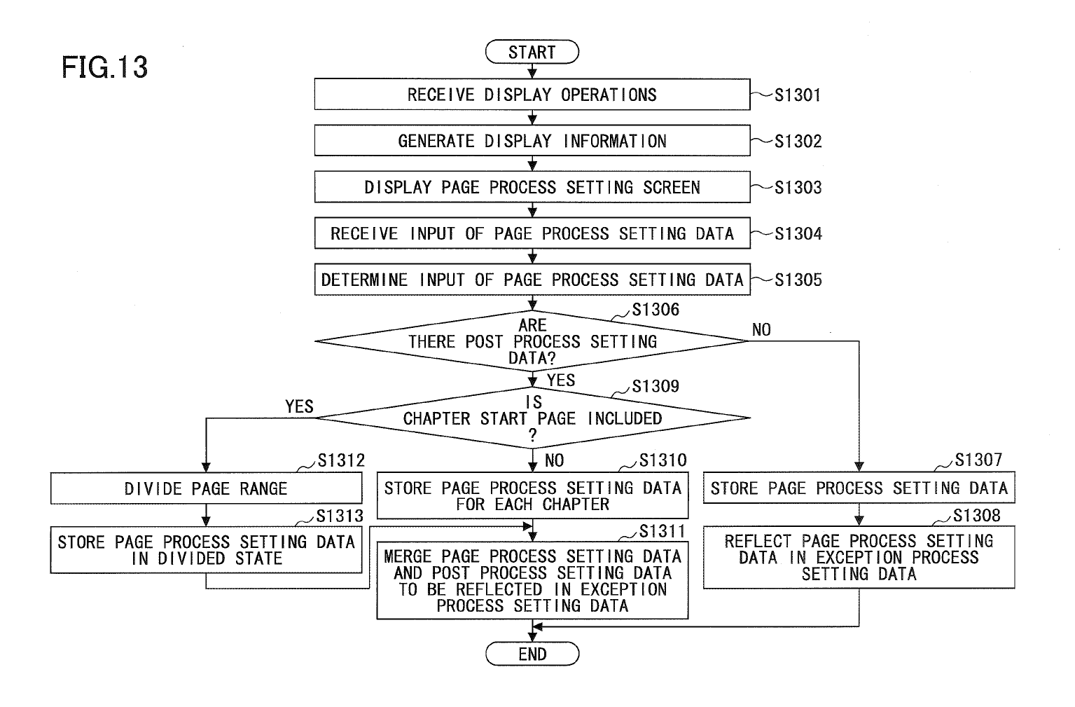

Next, a process in which the printer driver 400 according to the embodiment sets a page process condition in accordance with a user's operations is described with reference to FIG. 13. FIG. 13 is a flowchart illustrating a process in which the printer driver 400 according to the embodiment sets a page process condition in accordance with a user's operations.

As illustrated in FIG. 13, when the printer driver 400 according to the embodiment sets a page process condition in accordance with a user's operations, the UI controller 411 receives an operation for displaying a page process setting screen via the operations controller 600 (step S1301), and informs the UI display controller 412 of a request for displaying the page process setting screen.

When the UI display controller 412 receives the request for displaying the page process setting screen from the UI controller 411, the UI display controller 412 generates display information for displaying the page process setting screen (step S1302) to display the page process setting screen on the display panel 103 by following the generated display information (step S1303). That is, in this embodiment, the process in step S1303 is executed as a page process function displaying step.

Then, the setting data input part 413 receives an input of page process setting data via the page process setting screen (step S1304), subsequently receives determination of the input page process setting data (step S1305), and sends a report of the determined page process setting data to the UI controller 411. That is, in this embodiment, the processes in step S1304 and S1305 are executed as a post process function displaying reception step.

When the UI controller 411 receives the report of the determination of the input page process setting data, the UI controller 411 determines whether the setting data storage part 430 stores the post process setting data (step S1306).

When the UI controller 411 determines that the setting data storage part 430 does not store the post process setting data (“NO” in step S1306), the setting data input part 413 stores the determined page process setting data in the setting data storage part 430 (step S1307), and reflects the stored page process setting data in the exception process setting data (step S1308).

On the other hand, when the UI controller 411 determines that the setting data storage part 430 stores the post process setting data (“YES” in step S1306), the UI controller 411 refers to the post process setting data stored in the setting data storage part 430 and determines whether a start page of a chapter in which the post process conditions are set is included within a page range of the page process setting data determined in step S1305 (step S1309). That is, in this embodiment, the process in step S1309 is executed as a determination step.

When the UI controller 411 determines that a start page of a chapter in which the post process conditions are set is not included within the above-described page range of the page process setting data (“NO” in step S1309), the setting data input part 413 stores the page process setting data determined in step S1305 in association with the chapter to which the above-described page range belongs in the setting data storage part 430 (step S1310), and then merges the page process setting data and the post process setting data to reflect the merged result in the exception process setting data (step S1311).

On the other hand, when the UI controller 411 determines that a start page of a chapter in which the post process conditions are set is included within the above-described page range of the page process setting data (“YES” in step S1309), the UI controller 411 divides the page range in the page process setting data determined in step S1305 between the above-described start page and a page previous to the start page (step S1312). That is, in this embodiment, the process in step S1312 is executed as a division step.

Then, the setting data input part 413 stores the determined page process setting data determined in step S1305 in a state divided in step S1312 in the setting data storage part 430 (step S1313), and merges the page process setting data and the post process setting data to reflect the merged result in the exception processing setting data (step S1311).

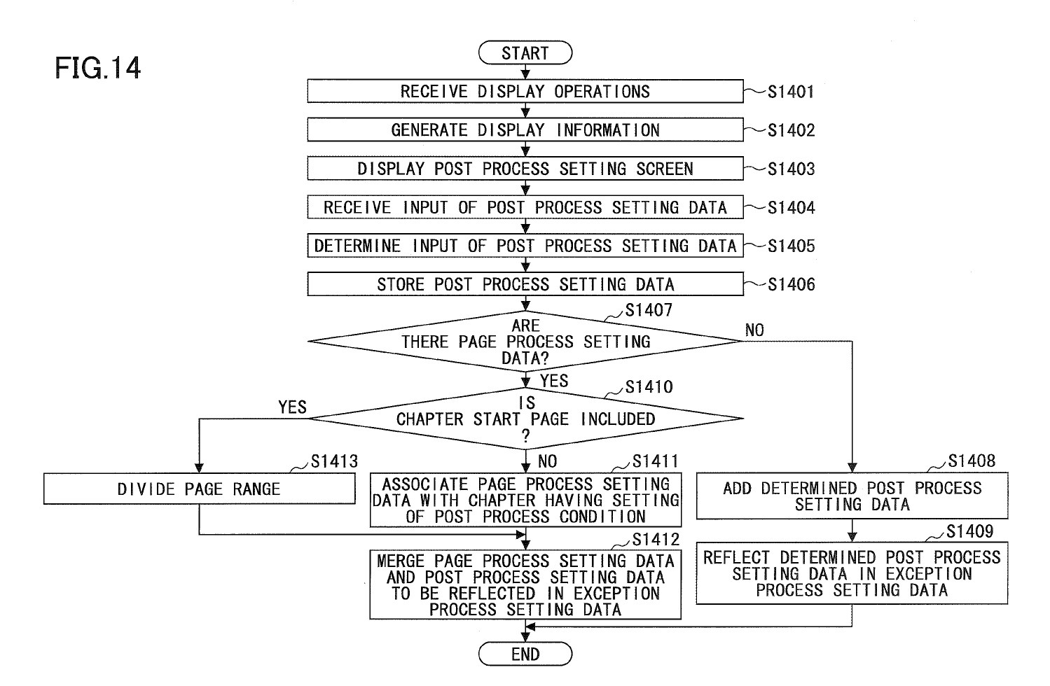

Next, a process in which the printer driver 400 according to the embodiment sets a post process condition in accordance with a user's operations is described with reference to FIG. 14. FIG. 14 is a flowchart illustrating a process in which the printer driver 400 according to the embodiment sets a post process condition in accordance with a user's operations.

As illustrated in FIG. 14, when the printer driver 400 according to the embodiment sets a post process condition in accordance with a user's operations, the UI controller 411 receives an operation for displaying a post process setting screen via the operations controller 600 (step S1401), and informs the UI display controller 412 of a request for displaying the post process setting screen.

When the UI display controller 412 receives the request for displaying the post process setting screen from the UI controller 411, the UI display controller 412 generates display information for displaying the post process setting screen (step S1402) to display the post process setting screen on the display panel 103 in accordance with the generated display information (step S1403).

Then, the setting data input part 413 receives an input of the post process setting data via the post process setting screen (step S1404), subsequently receives determination of the input post process setting data (step S1405), then stores the determined post process setting data in the setting data storage part 430 (step S1406), and sends a report of the determined post process setting data to the UI controller 411. That is, in this embodiment, the processes in step S1404 and S1405 are executed as a post process function displaying reception step.

When the UI controller 411 receives from the setting data input part 413 the report of the post process setting data being stored, the UI controller 411 determines whether the setting data storage part 430 stores the page process setting data (step S1407).

When the UI controller 411 determines that the post process setting data are not stored in the determination process of step S1407 (“NO” in step S1407), the UI controller 411 stores the post process setting data determined in step S1405 in the setting data storage part 430 (step S1408), and reflects the stored post process setting data in the exception process setting data (step S1409).

On the other hand, when the UI controller 411 determines that the post process setting data are stored in the determination process of step S1407 (“YES” in step S1407), the UI controller 411 determines whether there is, among the page ranges of the page process setting data, a page range that includes a start page of the chapter in which the post process conditions determined in step S1405 are set by referring to the page process setting data stored in the setting data storage part 430 (step S1410). That is, in this embodiment, the process in step S1410 is executed as a determination step.

When the UI controller 411 determines that there is no page range that includes the above-described start page in the determination process of step S1410 (“NO” in step S1410), the setting data input part 413 associates the chapter in which the post process condition determined in step S1415 are set with the page process setting data belonging to that chapter (step S1411), and merges the page process setting data and the post process setting data to reflect the merged result in the exception process setting data (step S1412).

On the other hand, when the UI controller 411 determines that there is a page range that includes the above-described start page in the determination process of step S1410 (“YES” in step S1410), the UI controller 411 divides the page range at an interval between the above-described start page and a page previous to the start page (the previous page) (step S1413). That is, in this embodiment, the process in step S1413 is executed as a division step.

Then, the setting data input part 413 merges the post process setting data determined in step S1405 and the page process setting data to reflect the merged result in the exception process setting data (step S1412).

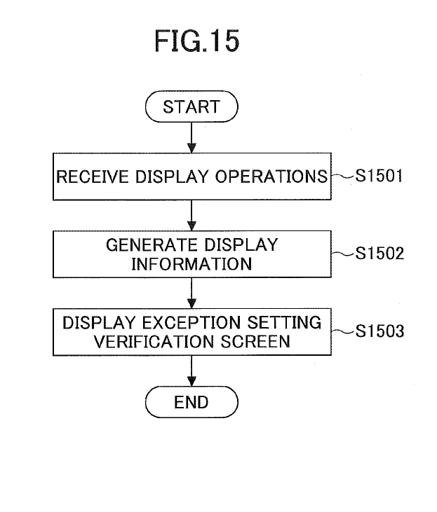

Next, a process in which the printer driver 400 according to the embodiment displays an exception setting verification screen in accordance with a user's operations is described with reference to FIG. 15. FIG. 15 is a flowchart illustrating a process in which the printer driver 400 according to the embodiment displays an exception setting verification screen in accordance with a user's operations.

When the printer driver 400 according to the embodiment displays an exception setting verification screen in accordance with a user's operations, the UI controller 411 receives an operation for displaying an exception setting screen via the operations controller 600 (step S1501), and informs the UI display controller 412 of a request for displaying the exception setting verification screen.

When the UI display controller 412 receives the request for displaying the exception setting verification screen from the UI controller 411, the UI display controller 412 generates display information for displaying the exception setting verification screen (step S1502) so as to display the exception setting verification screen on the display panel 103 in accordance with the generated display information (step S1503). That is, in the present embodiment, the exception setting verification screen is displayed as a list of the functions applied to each page range on the display part (display panel 103) to execute the process of step S1503 as a list display step.

As described above, one of the main functions of the printer driver 400 according to the embodiment may be the capability of displaying on a verification screen the setting contents associated with the post process conditions and the setting contents associated with the page process conditions by each chapter as a unit in which the post process conditions are set.

Hence, the printer driver 400 according to the embodiment may enable the users to easily check the setting contents of the print conditions as well as enabling the users to easily verify a relationship between the page range in which the page process conditions are set and the page range in which the post process conditions are set.

Further, another main function of the printer driver 400 may be the capability of dividing, when the same page process conditions are set through the two or more chapters in which the post process conditions are set, the page range in which the page process conditions are set between the start page and a page previous to the start page of the chapter having the same (duplicated) page range in which the same post process conditions are set, and displaying the divided page ranges on the verification screen.

Hence, in the printer driver 400 according to the embodiment, in a case where the page process conditions are set through the two or more chapters in which the post process conditions are set, the users may be able to easily verify the setting contents of the print conditions as well as easily verify a relationship between the page range in which the page process conditions are set and the page range in which the post process conditions are set.

With this configuration, the printer driver 400 according to the embodiment may enable the users to easily verify whether the desired print settings are appropriately selected when the users set intended functions with respect to image forming apparatuses, thereby improving the convenience of the users.

Note that the above-described embodiment illustrates the printer driver 400 for utilizing the image forming apparatus 2; however, the printer driver 400 may be implemented by a function setting program for setting functions utilizing with respect to the image forming apparatus 2 and thus, the function setting program may be applied in a manner similar to the printer driver 400.

Further, as illustrated by the example of FIG. 8, the exception setting verification screen according to the embodiment is configured to display the setting contents associated with the post process conditions and the setting contents associated with the page process conditions by each chapter in which the post process conditions are set. However, in addition, the exception setting verification screen according to the embodiment may exhibit the similar effects when the exception setting verification screen is configured to display the page range to which post process functions are applied in association, among the page ranges to which the post process functions are applied, the page range to which image process functions are applied.

According to the embodiments of the present invention, when the users set the functions with respect to the image forming apparatus, the convenience of the users may be improved.

The present invention is not limited to the specifically disclosed embodiments, and variations and modifications may be made without departing from the scope of the present invention.

The present application is based on and claims the benefit of priority of Japanese Priority Application No. 2014-085692 filed on Apr. 17, 2014, the entire contents of which are hereby incorporated herein by reference.

What is claimed is:

1. A non-transitory recording medium storing a function setting program for setting functions including page process functions and post process functions for utilizing an image forming apparatus, the function setting program, when processed by a processor, executing a process comprising:
receiving a page range to which, among the functions available in the image forming apparatus, the page process functions settable by page unit are applied, by each of the page process functions;
receiving a page range to which, among the functions available in the image forming apparatus, the post process functions executable after forming an image are applied, by each of the post process functions; and
displaying a list of the functions applied to each of the page ranges on a display part by associating the page range to which the post process functions are applied, among the page ranges to which the post process functions are applied, the page range to which image process functions are applied so as to identify types of the functions applied to a corresponding one of the page ranges.

2. The non-transitory recording medium as claimed in claim 1, further comprising:
determining whether any one of the page ranges to which the page process functions are applied includes a start page of the page range to which the post process functions are applied;
dividing, when any one of the page ranges is determined to include the start page, the page range determined to include the start page between the start page and one page previous to the start page; and
displaying the list of the functions on the display part in a state in which the page range determined to include the start page is divided.

3. The non-transitory recording medium as claimed in claim 1, wherein
the receiving the page range to which the page process functions are applied includes displaying each of the page ranges received as the page range to which the post process functions are to be applied as the page range to which, among the functions available in the image forming apparatus, the page process functions settable by page unit are applied so as to specify each of the displayed page process functions to be applied.

4. The non-transitory recording medium as claimed in claim 1, wherein
the displaying the list includes displaying on the display part the list of the functions including identification information for identifying each of the page ranges to which the post process functions are applied.

5. An information processing apparatus executing a function setting program for setting functions including page process functions and post process functions for utilizing an image forming apparatus, the information processing apparatus comprising a processor programmed to execute a process including:
receiving a page range to which, among the functions available in the image forming apparatus, the page process functions settable by page unit are applied, by each of the page process functions;
receiving a page range to which, among the functions available in the image forming apparatus, the post process functions executable after forming an image are applied, by each of the post process functions; and
displaying a list of the functions applied to each of the page ranges on a display part by associating the page range to which the post process functions are applied, among the page ranges to which the post process functions are applied, the page range to which image process functions are applied so as to identify types of the functions applied to a corresponding one of the page ranges.

6. A method for setting functions including page process functions and post process functions for utilizing an image forming apparatus, the method comprising:
receiving a page range to which the page process functions settable by page unit are applied, by each of the page process functions;
receiving a page range to which, among the functions available in the image forming apparatus, the post process functions executable after forming an image are applied, by each of the post process functions; and
displaying a list of the functions applied to each of the page ranges on a display part by associating the page range to which the post process functions are applied, among the page ranges to which the post process functions are applied, the page range to which image process functions are applied so as to identify types of the functions applied to a corresponding one of the page ranges.
